(19) United States
(12) Patent Application Publication
(10) Pub. No.: US 2023/0395867 A1
(43) Pub. Date: Dec. 7, 2023

(54) MANUFACTURING METHOD FOR ELECTRODE BODY, MANUFACTURING APPARATUS FOR ELECTRODE BODY, AND ELECTRODE BODY

(71) Applicant: TOYOTA JIDOSHA KABUSHIKI KAISHA, Toyota-shi (JP)

(72) Inventor: Kenichi KAKISHITA, Nagoya-shi (JP)

(21) Appl. No.: 18/304,437

(22) Filed: Apr. 21, 2023

(30) Foreign Application Priority Data
Jun. 6, 2022 (JP) 2022-091466

(51) Int. Cl. H01M 10/0583; H01M 50/46; H01M 10/04

(52) U.S. Cl. CPC H01M 10/0583; H01M 50/46; H01M 10/0409

(57) ABSTRACT

This disclosure achieves the object by providing a manufacturing method for an electrode body, the manufacturing method including: a preparing step of preparing an electrode sheet including one separator, a plurality of first electrodes placed on a first surface of the separator, and a plurality of second electrodes placed on a second surface opposite from the first surface of the separator; and a laminating step of laminating the first electrodes and the second electrodes in the electrode sheet alternately via the separator. The electrode sheet satisfies predetermined conditions (i) to (iii) in a plan view in the thickness direction of the electrode sheet. In the laminating step, the first electrodes and the second electrodes are laminated alternately via the separator while the separator placed on a side surface of each of the first electrodes is brought into contact with a wall portion inclined from the vertical direction.

### CROSS-REFERENCE TO RELATED APPLICATION

This application claims priority to Japanese Patent Application No. 2022-091466 filed on Jun. 6, 2022, incorporated herein by reference in its entirety.

### BACKGROUND

### 1. Technical Field

This disclosure relates to a manufacturing method for an electrode body, a manufacturing apparatus for an electrode body, and an electrode body.

### 2. Description of Related Art

An electrode body used for a battery such as a lithium-ion secondary battery includes, for example, a positive electrode (cathode), a separator, and a negative electrode (anode). For example, Japanese Patent No. 5697276 (JP 5697276 B) describes an electrode assembly having a cathode-separator-anode structure in which a plurality of first unit electrodes and a second electrode sheet are wound such that the first unit electrodes face the second electrode sheet via a separator sheet.

### SUMMARY

In JP 5697276 B, the electrode assembly (an electrode body) is manufactured by a so-called winding method. In this case, when a positional deviation between electrodes occurs at the time of winding, the positional deviation causes an influence cumulatively. Because of this, when the winding speed is raised to improve productivity, for example, the electrodes (particularly, an edge portion) may break under the accumulated influences of the positional deviation.

This disclosure is accomplished in view of the above circumstances, and an main object of this disclosure is to provide a manufacturing method for an electrode body that balances improvement in productivity with restraint of breakage in an electrode.

[1] A manufacturing method for an electrode body includes a preparing step and a laminating step. The preparing step is a step of preparing an electrode sheet including one separator, a plurality of first electrodes placed on a first surface of the separator, and a plurality of second electrodes placed on a second surface opposite from the first surface of the separator. The laminating step is a step of laminating the first electrodes and the second electrodes in the electrode sheet alternately via the separator. The electrode sheet satisfies the following conditions (i) to (iii) in a plan view in the thickness direction of the electrode sheet: (i) the first electrodes and the second electrodes are placed alternately in a first direction; (ii) the first electrodes and the second electrodes are placed not to overlap with each other; and (iii) the first electrodes have an area larger than the area of the second electrodes. In the laminating step, the first electrodes and the second electrodes are laminated alternately via the separator while the separator placed on a side surface of each of the first electrodes is brought into contact with a wall portion inclined from the vertical direction.

[2] In the manufacturing method described in [1], the separator in the electrode body may include, in a sectional view of the electrode body in the lamination direction, unit structures each including a first facing portion, a second facing portion, and a first connecting portion, and a second connecting portion connecting adjacent unit structures to each other. The first facing portion may face a corresponding first electrode and have a length corresponding to a length of the corresponding first electrode in the width direction. The second facing portion may face a corresponding second electrode and have a length corresponding to a length of the corresponding second electrode in the width direction. The first connecting portion may connect the first facing portion and the second facing portion to each other and cover a side surface of the corresponding first electrode. The second connecting portion may connect the first facing portion in a first unit structure out of the adjacent unit structures to the second facing portion in a second unit structure out of the adjacent unit structures.

[3] In the manufacturing method described in [2], in a plan view of the electrode sheet from the thickness direction, W_{γ} may satisfy W_{γ}=T₁+ε(W_{α}−W_{β})/2 (0.9≤ε≤1.1), where W_{α} indicates a length of the corresponding first electrode in the first direction, W_{β} indicates a length of the corresponding second electrode in the first direction, W_{γ} indicates a length of a first blank portion corresponding to the first connecting portion in the first direction, and T₁ indicates a thickness of the first electrode.

[4] In the manufacturing method described in any of [1] to [3], the first electrodes may each include a first current collection layer, and a first active material layer placed on each surface of the first current collection layer, and the second electrodes may each includes a second current collection layer, and a second active material layer placed on each surface of the second current collection layer.

[5] In the manufacturing method described in any of [1] to [4], the first electrodes may be negative electrodes, and the second electrodes may be positive electrodes.

[6] A manufacturing apparatus for an electrode body is a manufacturing apparatus used for the manufacturing method described in any of [1] to [5], and the manufacturing apparatus includes a conveyance member and a storage member. The conveyance member is configured to convey the electrode sheet. In the storage member, the electrode sheet conveyed from the conveyance member is stored, and the storage member includes the wall portion.

[7] An electrode body includes first electrodes and second electrodes laminated alternately via one separator. The separator includes, in a sectional view of the electrode body in the lamination direction, unit structures each including a first facing portion, a second facing portion, and a first connecting portion, and a second connecting portion connecting adjacent unit structures to each other. The first facing portion faces a corresponding first electrode and has a length corresponding to a length of the corresponding first electrode in the width direction. The second facing portion faces a corresponding second electrode and has a length corresponding to a length of the corresponding second electrode in the width direction. The first connecting portion connects the first facing portion and the second facing portion to each other and covers a side surface of the corresponding first electrode. The second connecting portion connects the first facing portion in a first unit structure out of the adjacent unit structures to the second facing portion in a second unit structure out of the adjacent unit structures.

The manufacturing method of the electrode body in this disclosure can balance improvement in productivity with restraint of breakage of an electrode.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic plan view illustrating an electrode sheet in this disclosure;

FIG. 1B is a schematic sectional view illustrating the electrode sheet in this disclosure;

FIG. 2A is a schematic sectional view illustrating a first electrode in this disclosure;

FIG. 2B is a schematic sectional view illustrating a second electrode in this disclosure;

FIG. 3 is a schematic sectional view illustrating a laminating step in this disclosure;

FIG. 4 is an enlarged view illustrating a wall portion 71 in FIG. 3 and its peripheral area in an enlarged manner;

FIG. 5 is a schematic sectional view illustrating an electrode body in this disclosure;

FIG. 6A is a schematic sectional view to describe the laminating step in this disclosure;

FIG. 6B is a schematic sectional view to describe the laminating step in this disclosure;

FIG. 7A is a schematic sectional view to describe the laminating step in this disclosure;

FIG. 7B is a schematic sectional view to describe the laminating step in this disclosure;

FIG. 8A is a schematic sectional view to describe the laminating step in this disclosure;

FIG. 8B is a schematic sectional view to describe the laminating step in this disclosure;

FIG. 9A is a schematic sectional view to describe the laminating step in this disclosure; and

FIG. 9B is a schematic sectional view to describe the laminating step in this disclosure.

### DETAILED DESCRIPTION OF EMBODIMENTS

The following describes details of a manufacturing method for an electrode body, a manufacturing apparatus for an electrode body, and an electrode body according to this disclosure, with reference to the drawings. Each of the following drawings is illustrated schematically, and the magnitude and the shape of each part are exaggerated appropriately to facilitate understanding. Further, in the present specification, in a case where merely the term “above” or “below” is described to express an arrangement of a second member relative to a first member, this arrangement includes both a case where the second member is placed right above or right below the first member such that the second member makes contact with the first member, and a case where the second member is placed above or below the first member via a third member, unless otherwise specified.

A. Manufacturing Method for Electrode Body

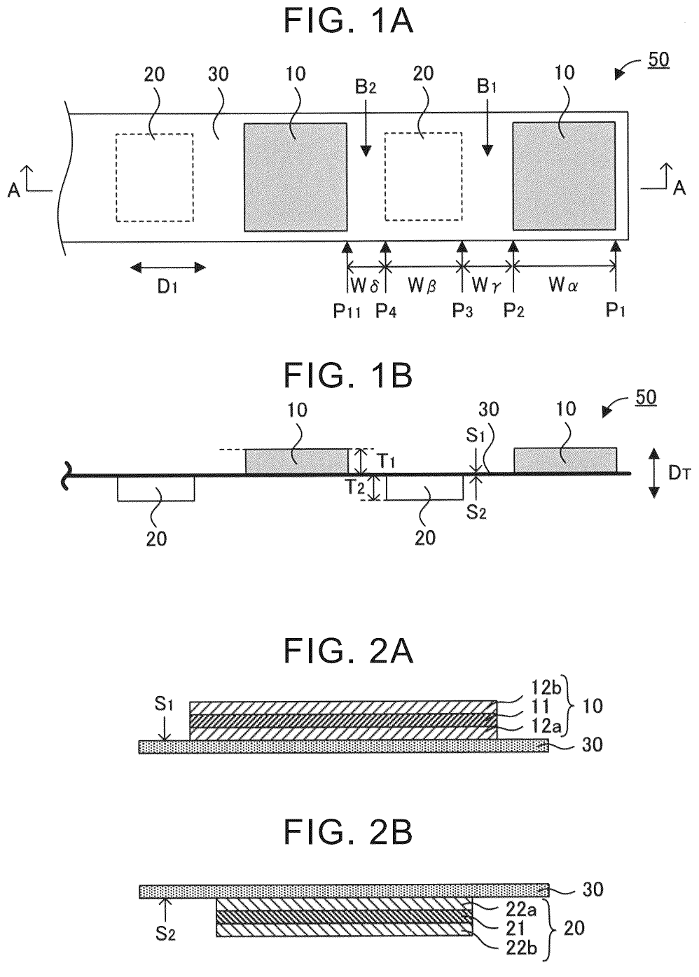

FIG. 1A is a schematic plan view illustrating an electrode sheet in this disclosure, and FIG. 1B is a sectional view taken along a line A-A in FIG. 1A. As illustrated in FIGS. 1A, 1B, an electrode sheet 50 includes one separator 30, a plurality of first electrodes 10 placed on a first surface S₁ of the separator 30, and a plurality of second electrodes 20 placed on a second surface S₂ opposite from the first surface S₁ of the separator 30. Further, the electrode sheet 50 satisfies the following conditions (i) to (iii) in a plan view in a thickness direction DT. More specifically, the conditions are as follows: (i) the first electrodes 10 and the second electrodes 20 are placed alternately in a first direction D₁; (ii) the first electrodes 10 and the second electrodes 20 are placed not to overlap each other; and (iii) the first electrodes 10 have an area larger than the area of the second electrodes 20.

FIG. 2A is a schematic sectional view illustrating the first electrode in this disclosure, and FIG. 2B is a schematic sectional view illustrating the second electrode in this disclosure. The first electrode 10 illustrated in FIG. 2A is placed on the first surface S₁ of the separator 30. Further, the first electrode 10 includes a first current collection layer 11, a first active material layer 12a placed on a separator-30 side surface of the first current collection layer 11, and a first active material layer 12b placed on the opposite surface of the first current collection layer 11 from the first active material layer 12a. In the meantime, the second electrode 20 illustrated in FIG. 2B is placed on the second surface S₂ of the separator 30. Further, the second electrode 20 includes a second current collection layer 21, a second active material layer 22a placed on a separator-30 side surface of the second current collection layer 21, and a second active material layer 22b placed on the opposite surface of the second current collection layer 21 from the second active material layer 22a.

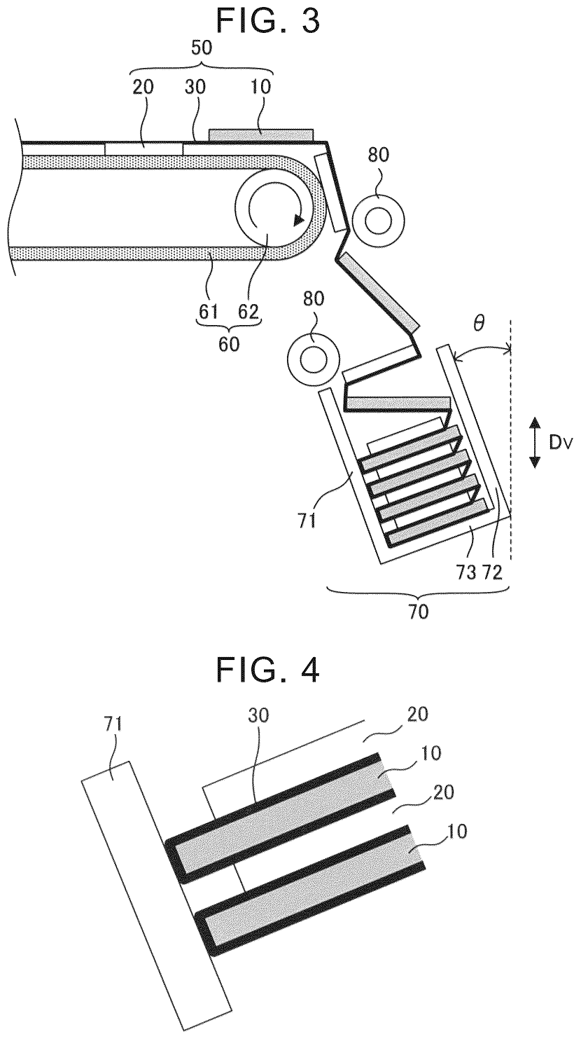

FIG. 3 is a schematic sectional view illustrating a laminating step in this disclosure. FIG. 4 is an enlarged view illustrating a wall portion 71 in FIG. 3 and its peripheral area in an enlarged manner. As illustrated in FIGS. 3, 4, in the laminating step, the first electrodes 10 and the second electrodes 20 in the electrode sheet 50 are laminated alternately via the separator 30. In this disclosure, while the separator 30 placed on a side surface of the first electrode 10 is brought into contact with the wall portion 71 inclined from a vertical direction D_{V}, the first electrodes 10 and the second electrodes 20 are laminated alternately via the separator 30.

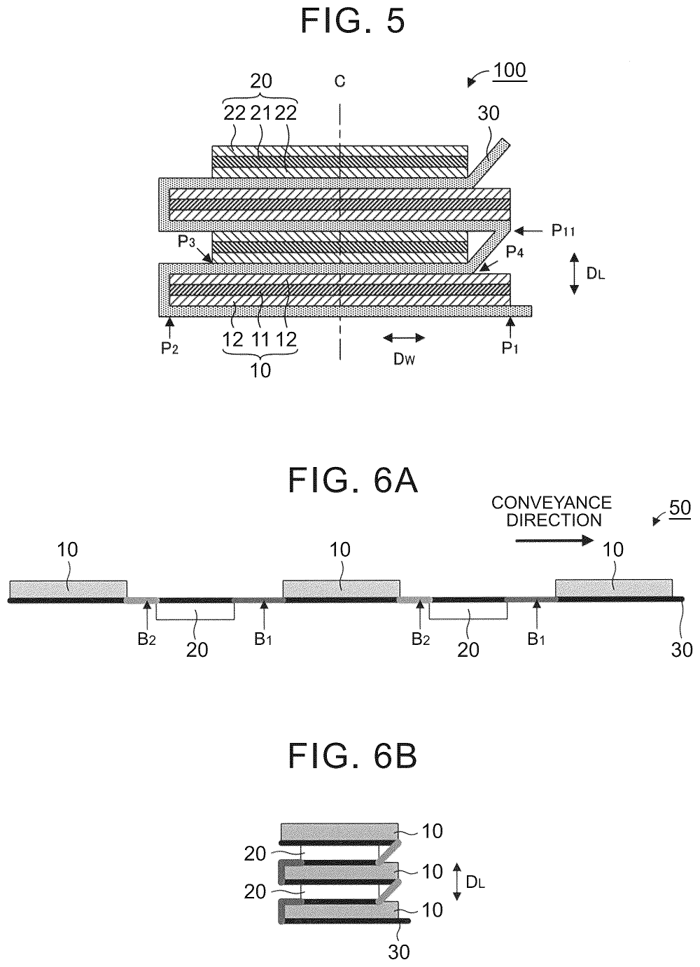

FIG. 5 is a schematic sectional view illustrating an electrode body in this disclosure. As illustrated in FIG. 5, the first electrodes 10 and the second electrodes 20 are laminated alternately via one separator 30 in a lamination direction D_{L} in an electrode body 100. Further, the separator 30 has a unit structure including a first facing portion, a second facing portion, and a first connecting portion. Here, the first facing portion is a part facing the first electrode 10 and having a length corresponding to the length of the first electrode in a width direction D_{W}. In FIG. 5, a part from a position P₁ to a position P₂ corresponds to the first facing portion. The second facing portion is a part facing the second electrode and having a length corresponding to the length of the second electrode 20 in the width direction D_{W}. In FIG. 5, a part from a position P₃ to a position P₄ corresponds to the second facing portion. The first connecting portion is a part connecting the first facing portion and the second facing portion to each other and covering a side surface of the first electrode 10. In FIG. 5, a part from the position P₂ to the position P₃ corresponds to the first connecting portion. The unit structure in the separator 30 corresponds to a part from the position P₁ to the position P₄. Further, a second connecting portion is a part connecting the first facing portion in a first unit structure out of adjacent unit structures to the second facing portion in a second unit structure out of the adjacent unit structures. In FIG. 5, a part from the position P₄ to a position Pu corresponds to the second connecting portion.

In this disclosure, the first electrodes and the second electrodes are laminated alternately via the separator by using a predetermined electrode sheet with the use of the wall portion inclined from the vertical direction, thereby making it possible to balance improvement in productivity with restraint of breakage of the electrodes. As described above, in a case where an electrode body is manufactured by the winding method, when a positional deviation between electrodes occurs at the time of winding, the positional deviation causes an influence cumulatively. Accordingly, when the winding speed is raised to improve productivity, for example, the electrodes (particularly, an edge portion) may break under the accumulated influences of the positional deviation. In contrast, in this disclosure, the first electrodes and the second electrodes are laminated alternately via the separator with the use of the wall portion inclined from the vertical direction. The positional relationship between the first electrode and the second electrode in the lamination direction is defined by the length of the separator (the length of a first blank portion (described later)) brought into contact with the wall portion, and therefore, there is such an advantage that the influence of a positional deviation between electrodes does not occur cumulatively. On that account, even when the speed of the electrode sheet is raised to improve productivity, for example, it is possible to restrain the electrodes from breaking.

1. Preparing Step

A preparing step in this disclosure is a step of preparing a predetermined electrode sheet. As illustrated in FIG. 1B, the electrode sheet 50 includes the separator 30, the first electrodes 10 placed on the first surface S₁ of the separator 30, and the second electrodes 20 placed on the second surface S₂ opposite from the first surface S₁ of the separator 30.

The electrode sheet in this disclosure satisfies the following conditions (i) to (iii) in a plan view in the thickness direction. The “thickness direction of the electrode sheet” indicates a normal direction of a principal surface (the first surface and the second surface) of the separator.

The condition (i) is as follows. That is, the first electrodes and the second electrodes are placed alternately in the first direction. The first direction is typically the longitudinal direction of the electrode sheet. The electrode sheet is conveyed in its longitudinal direction, in general. For example, in FIG. 1A, the first electrodes 10 and the second electrodes 20 are placed alternately from the right side of the figure toward the left side of the figure.

The condition (ii) is as follows. That is, the first electrodes and the second electrodes are placed not to overlap with each other. More specifically, in the first direction, a blank portion in which the first electrode and the second electrode are not present is placed between the first electrode and the second electrode. For example, the electrode sheet 50 illustrated in FIG. 1A includes a first blank portion B₁ corresponding to the first connecting portion (described later) and a second blank portion B₂ corresponding to the second connecting portion (described later).

As illustrated in FIG. 1A, in the first direction D₁, W_{α} indicates the length (width) of the first electrode 10, W_{β} indicates the length (width) of the second electrode, W_{γ} indicates the length (width) of the first blank portion B₁, and W_{δ} indicates the length (width) of the second blank portion B₂. Further, T₁ indicates the thickness of the first electrode 10, and T₂ indicates the thickness of the second electrode 20.

The positional relationship between the first electrode and the second electrode in the lamination direction is defined by the length W_{γ} of the first blank portion B₁ brought into contact with the wall portion. W_{γ} is not limited in particular, provided that W_{γ} has a value that allows the first electrode and the second electrode to be laminated via the separator, but it is preferable to satisfy W_{γ}=T₁+ε(W_{α}−W_{β})/2 (0.9≤ε≤1.1). By satisfying this relationship, it is possible to obtain an electrode body in which the center of the first electrode accords with the center of the second electrode in the lamination direction. For example, in FIG. 5, the center of the first electrode and the center of the second electrode accord with a center line C. Here, e may be equal to or more than 0.95 or may be equal to or more than 0.98. In the meantime, e may be equal to or less than 1.05 or may be equal to or less than 1.02.

Further, W_{δ} is not limited in particular, provided that W_{δ} has a value that allows the first electrode and the second electrode to be laminated via the separator, but for example, it is preferable to satisfy W_{δ}≥{(T₂)²+((W_{α}−W_{β})/2)²}^{1/2}. As described above, since the positional relationship between the first electrode and the second electrode in the lamination direction is defined by the length W_{γ} of the first blank portion B₁ brought into contact with the wall portion, WO does not affect the positional relationship, basically.

The condition (iii) is as follows. That is, the area of the first electrode is larger than the area of the second electrode. For example, as illustrated in FIG. 1A, the area of the first electrode 10 is larger than the area of the second electrode 20. Here, when S a indicates the area of first electrode 10, and S_{β} indicates the area of the second electrode 20, the ratio of S_{α} to S_{β} (S_{α}/S_{β}) is, for example, equal to or more than 1.01, may be equal to or more than 1.05, or may be equal to or more than 1.1. Meanwhile, S_{α}/S_{β} is, for example, equal to or less than 1.5. Respective shapes of the first electrode and the second electrode in a plan view are not limited in particular but may be rectangular shapes such as a square shape and an oblong shape, for example. In a case where a rectangular shape includes a first side, a second side connected to the first side, a third side connected to the second side and facing the first side, and a fourth side connected to the third side and the first side, it is preferable that the first side and the third side be placed parallel to the first direction. Further, it is preferable that the second side and the fourth side be placed parallel to the second direction perpendicular to the first direction.

When W_{α} indicates the length (width) of the first electrode in the first direction, and W_{β} indicates the length (width) of the second electrode in the first direction, it is preferable that W_{α} be larger than W_{β}. The ratio of W_{α} to W_{β} (W_{α}/W_{β}) is, for example, equal to or more than 1.01, may be equal to or more than 1.05, or may be equal to or more than 1.1. Meanwhile, W_{α}/W_{β} is, for example, equal to or less than 1.5.

When D_{α} indicates the length (depth) of the first electrode in the second direction perpendicular to the first direction, and Do indicates the length (depth) of the second electrode in the second direction, it is preferable that D_{α} be larger than D_{β}. The ratio of D_{α} to D_{β} (D_{α}/D_{β}) is, for example, equal to or more than 1.01, may be equal to or more than 1.05, or may be equal to or more than 1.1. Meanwhile, D_{α}/D_{β} is, for example, equal to or less than 1.5.

The electrode sheet includes one separator, a plurality of first electrodes, and a plurality of second electrodes. The separator is a porous membrane, in general. Examples of the material for the separator include resins such as polyethylene (PE), polypropylene (PP), polyester, cellulose, and polyamide, for example. The separator may have a single-layered structure or may have a multi-layered structure. Examples of the separator having a multiple-layered structure include a separator having a two-layer structure of PE/PP, and a separator having a three-layer structure of PP/PE/PP or PE/PP/PE, for example. Further, the separator may be made of a woven fabric or may be made of a nonwoven fabric. The thickness of the separator is not limited in particular but is equal to or more than 0.1 μm but equal to or less than 1 mm, for example.

The first electrode includes, for example, a first current collection layer, and a first active material layer placed on each surface of the first current collection layer. Further, the first electrode is a positive electrode or a negative electrode. In a case where the first electrode is a positive electrode, the first electrode includes a positive-electrode current collection layer and a positive-electrode active material layer. In the meantime, in a case where the first electrode is a negative electrode, the first electrode includes a negative-electrode current collection layer and a negative-electrode active material layer. It is preferable that the first electrode be a negative electrode. This is because it is possible to restrain deposition of dendrite.

The second electrode includes, for example, a second current collection layer, and a second active material layer placed on each surface of the second current collection layer. Further, the second electrode is a positive electrode or a negative electrode. In a case where the first electrode is a positive electrode, the second electrode is a negative electrode and includes a negative-electrode current collection layer and a negative-electrode active material layer. In the meantime, in a case where the first electrode is a negative electrode, the second electrode is a positive electrode and includes a positive-electrode current collection layer and a positive-electrode active material layer. Materials used for the positive-electrode current collection layer, the positive-electrode active material layer, the negative-electrode current collection layer, and the negative-electrode active material layer are not limited in particular, and well-known materials are used.

2. Laminating Step

The laminating step in this disclosure is a step of laminating the first electrodes and the second electrodes in the electrode sheet alternately via the separator. In the laminating step, while the separator (the first blank portion) placed on the side surface of the first electrode is brought into contact with the wall portion inclined from the vertical direction, the first electrodes and the second electrodes are laminated alternately via the separator.

As illustrated in FIG. 3, 0 indicates the inclination angle of the wall portion 71 from the vertical direction D_{V}. Here, θ is, for example, equal to or more than 5°, may be equal to or more than 10°, or may be equal to or more than 30°. Meanwhile, θ is, for example, equal to or less than 60°.

As illustrated in FIG. 6A, the following assumes a case where the electrode sheet 50 is conveyed such that the first electrodes 10 are placed on the upper side and the second electrodes 20 are placed on the lower side on the basis of the separator 30. In this case, as illustrated in FIG. 6B, the separator 30 (the first facing portion), the first electrode the separator 30 (the second facing portion), and the second electrode 20 are laminated repeatedly in this order sequentially from the lower side in the lamination direction D_{L}. In FIG. 6B, the separator placed on the side surface of the first electrode 10 on the left side in the figure is brought into contact with the wall portion. Further, in FIG. 6B, the separator 30 (the first facing portion) is placed at the lowermost position in the lamination direction D_{L}, and therefore, it is possible to restrain breakage of the first electrode 10.

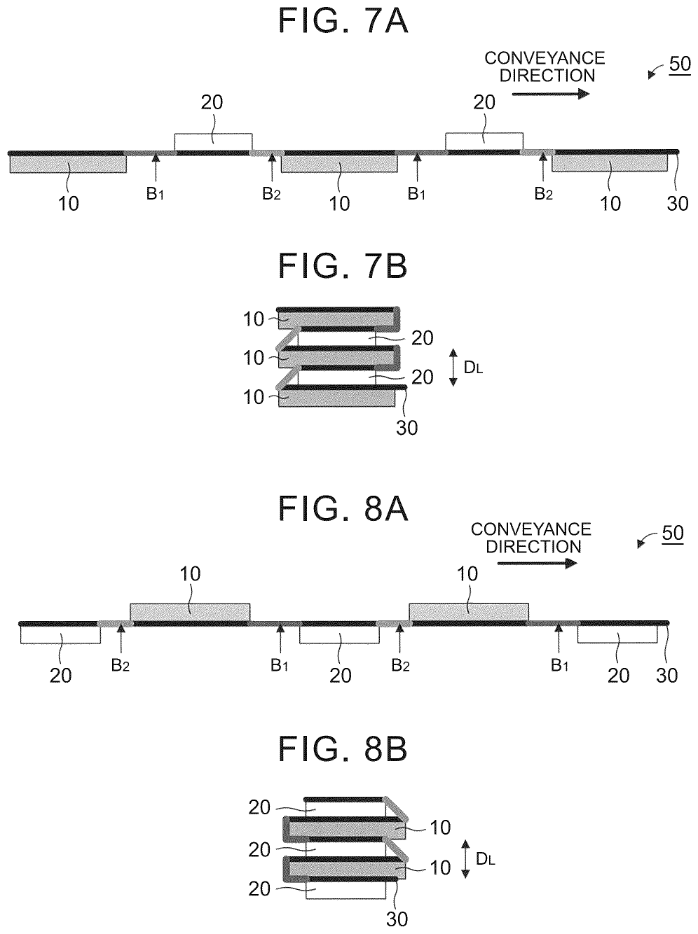

As illustrated in FIG. 7A, the following assumes a case where the electrode sheet 50 is conveyed such that the first electrodes 10 are placed on the lower side and the second electrodes 20 are placed on the upper side on the basis of the separator 30. In this case, as illustrated in FIG. 7B, the first electrode 10, the separator 30 (the first facing portion), the second electrode 20, and the separator 30 (the second facing portion) are laminated repeatedly in this order sequentially from the lower side in the lamination direction D_{L}. In FIG. 7B, the separator placed on the side surface of the first electrode 10 on the right side in the figure is brought into contact with the wall portion. Further, in FIG. 7B, the first electrode 10 is placed at the lowermost position in the lamination direction D_{L}, and therefore, it is preferable that a buffer material for preventing breakage of the first electrode 10 be placed in a bottom portion of a storage member.

As illustrated in FIG. 8A, the following assumes a case where the electrode sheet 50 is conveyed such that the first electrodes 10 are placed on the upper side and the second electrodes 20 are placed on the lower side on the basis of the separator 30. In FIG. 8A, differently from FIG. 6A, the second electrode 20 is conveyed prior to the first electrode in the laminating step. In this case, as illustrated in FIG. 8B, the second electrode 20, the separator 30 (the second facing portion), the first electrode 10, and the separator 30 (the first facing portion) are laminated repeatedly in this order sequentially from the lower side in the lamination direction D_{L}. In FIG. 8B, similarly to FIG. 6B, the separator placed on the side surface of the first electrode 10 on the left side in the figure is brought into contact with the wall portion.

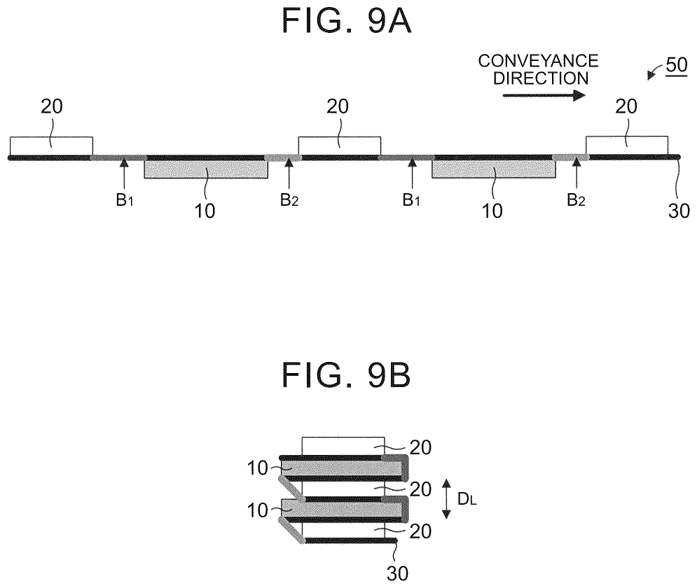

As illustrated in FIG. 9A, the following assumes a case where the electrode sheet 50 is conveyed such that the first electrodes 10 are placed on the lower side and the second electrodes 20 are placed on the upper side on the basis of the separator 30. In FIG. 9A, differently from FIG. 7A, the second electrode 20 is conveyed prior to the first electrode in the laminating step. In this case, as illustrated in FIG. 9B, the separator 30 (the second facing portion), the second electrode 20, the separator 30 (the first facing portion), and the first electrode 10 are laminated repeatedly in this order sequentially from the lower side in the lamination direction D_{L}. In FIG. 9B, similarly to FIG. 7B, the separator placed on the side surface of the first electrode 10 on the right side in the figure is brought into contact with the wall portion.

3. Electrode Body

The electrode body in this disclosure is an electrode body in which the first electrodes and the second electrodes are laminated alternately via one separator. The separator in the electrode body includes, in a sectional view in the lamination direction of the electrode body, the unit structure including the first facing portion, the second facing portion, and the first connecting portion, and the second connecting portion connecting adjacent unit structures to each other. The “lamination direction of the electrode body” indicates a direction where the first electrode and the second electrode are laminated via the separator.

As illustrated in FIG. 5, in a sectional view of the electrode body 100 in the lamination direction D_{L}, the first electrodes 10 and the second electrodes 20 are laminated alternately via one separator 30. The separator 30 includes the unit structure including the first facing portion (a part from the position P₁ to the position P₂), the second facing portion (a part from the position P₃ to the position P₄), and the first connecting portion (a part from the position P₂ to the position P₃). The separator 30 includes a plurality of unit structures configured as such. Further, the separator 30 includes the second connecting portion (a part from the position P₄ to the position Pu) connecting the first facing portion in a first unit structure out of the adjacent unit structures to the second facing portion in a second unit structure out of the adjacent unit structures.

This disclosure can provide a battery including the electrode body described above. The battery may include the electrode body, an electrolytic solution with which the electrode body is impregnated, and an outer packaging body in which the electrode body and the electrolytic solution are stored. The type of the electrolytic solution is not limited in particular, and a well-known electrolytic solution is used. Further, the type of the outer packaging body is not limited in particular, and a well-known outer packaging body is used. The type of the battery is not limited in particular, but the battery is a lithium-ion secondary battery, for example. The purpose of the battery is, for example, a power supply of a vehicle such as a hybrid electric vehicle (HEV), a plug-in hybrid electric vehicle (PHEV), a battery electric vehicle (BEV), a gasoline-fueled automobile, or a diesel powered automobile. Particularly, it is preferable that the battery be used for a drive power supply of a hybrid electric vehicle (HEV), a plug-in hybrid electric vehicle (PHEV), or a battery electric vehicle (BEV). Further, the battery in this disclosure may be used as a power supply of a movable body (e.g., a train, a vessel, an aircraft) other than the vehicle or may be used as a power supply of an electric appliance such as an information processing device.

B. Manufacturing Apparatus for Electrode Body

A manufacturing apparatus for an electrode body in this disclosure is used for the aforementioned manufacturing method for the electrode body and includes a conveyance member configured to convey the electrode sheet, and a storage member in which the electrode sheet conveyed from the conveyance member is stored, the storage member having the aforementioned wall portion.

In this disclosure, the manufacturing apparatus includes the storage member having the wall portion inclined from the vertical direction, and therefore, it is possible to achieve a manufacturing apparatus for an electrode body, the manufacturing apparatus balancing improvement in productivity with restraint of breakage of an electrode.

The conveyance member in this disclosure includes, for example, a support portion configured to support the electrode sheet, and a driving portion configured to move the position of the support portion. For example, a conveyance member 60 illustrated in FIG. 3 includes a support portion 61 configured to support the electrode sheet 50, and a driving portion 62 configured to move the position of the support portion 61. A concrete example of the conveyance member is a belt conveyor.

The storage member in this disclosure has at least the wall portion inclined from the vertical direction. For example, a storage member 70 illustrated in FIG. 3 includes a wall portion 71, a facing wall portion 72 facing the wall portion 71, and a bottom portion 73 connecting the wall portion 71 to the facing wall portion 72. In general, the installation position of the storage member is lower than the installation position of the conveyance member. That is, while the electrode sheet conveyed from the conveyance member is dropped, the first electrodes and the second electrodes are laminated alternately via the separator in the storage member. Further, at least one of the wall portion 71, the facing wall portion 72, and the bottom portion 73 may have one through-hole or two or more through-holes. For example, in the laminating step, a storage portion (a space where the electrode body is stored) of the storage member 70 is depressurized by use of the through-hole to form a depressurized atmosphere, thereby making it possible to restrain occurrence of a positional deviation between electrodes due to air resistance.

The manufacturing apparatus for the electrode body in this disclosure may include a guide member configured to assist the conveyance of the electrode sheet as needed. For example, the manufacturing apparatus of the electrode body, as illustrated in FIG. 3, includes a guide member 80 configured to assist the conveyance of the electrode sheet 50 in addition to the conveyance member 60 and the storage member 70. The manufacturing apparatus for the electrode body may include one guide member or two or more guide members.

C. Electrode Body

The electrode body in this disclosure is similar to what is described in “A. Manufacturing Method for Electrode Body,” and therefore, the electrode body in this disclosure is not described herein.

This disclosure is not limited to the above embodiment. The above embodiment is just an example and has a configuration substantially the same as the technical idea described in claims in this disclosure, and any configuration that can yield similar effects is included the technical scope of this disclosure.

What is claimed is:

1. A manufacturing method for an electrode body, the manufacturing method comprising:
a preparing step of preparing an electrode sheet including one separator, a plurality of first electrodes placed on a first surface of the separator, and a plurality of second electrodes placed on a second surface opposite from the first surface of the separator; and
a laminating step of laminating the first electrodes and the second electrodes in the electrode sheet alternately via the separator, wherein:
the electrode sheet satisfies the following conditions (i) to (iii) in a plan view in a thickness direction of the electrode sheet
(i) the first electrodes and the second electrodes are placed alternately in a first direction,
(ii) the first electrodes and the second electrodes are placed not to overlap with each other, and
(iii) the first electrodes have an area larger than an area of the second electrodes; and
in the laminating step, the first electrodes and the second electrodes are laminated alternately via the separator while the separator placed on a side surface of each of the first electrodes is brought into contact with a wall portion inclined from a vertical direction.

2. The manufacturing method according to claim 1, wherein:
the separator in the electrode body includes, in a sectional view of the electrode body in a lamination direction,
unit structures each including a first facing portion, a second facing portion, and a first connecting portion, and
a second connecting portion connecting adjacent unit structures to each other;
the first facing portion faces a corresponding first electrode and has a length corresponding to a length of the corresponding first electrode in a width direction;
the second facing portion faces a corresponding second electrode and has a length corresponding to a length of the corresponding second electrode in the width direction;
the first connecting portion connects the first facing portion and the second facing portion to each other and covers a side surface of the corresponding first electrode; and
the second connecting portion connects the first facing portion in a first unit structure out of the adjacent unit structures to the second facing portion in a second unit structure out of the adjacent unit structures.

3. The manufacturing method according to claim 2, wherein, in a plan view of the electrode sheet from the thickness direction, W_{γ} satisfies W_{γ}=T₁+ε(W_{α}−W_{β})/2 (0.9≤ε≤1.1), where W_{α} indicates a length of the corresponding first electrode in the first direction, W_{β} indicates a length of the corresponding second electrode in the first direction, W_{γ} indicates a length of a first blank portion corresponding to the first connecting portion in the first direction, and T₁ indicates a thickness of the first electrode.

4. The manufacturing method according to claim 1, wherein:
the first electrodes each include a first current collection layer, and a first active material layer placed on each surface of the first current collection layer; and
the second electrodes each includes a second current collection layer, and a second active material layer placed on each surface of the second current collection layer.

5. The manufacturing method according to claim 1, wherein the first electrodes are negative electrodes, and the second electrodes are positive electrodes.

6. A manufacturing apparatus for an electrode body, the manufacturing apparatus being used for the manufacturing method according to claim 1, the manufacturing apparatus comprising:
a conveyance member configured to convey the electrode sheet; and
a storage member in which the electrode sheet conveyed from the conveyance member is stored, the storage member including the wall portion.

7. An electrode body including first electrodes and second electrodes laminated alternately via one separator, wherein:
the separator includes, in a sectional view of the electrode body in a lamination direction,
unit structures each including a first facing portion, a second facing portion, and a first connecting portion, and
a second connecting portion connecting adjacent unit structures to each other;
the first facing portion faces a corresponding first electrode and has a length corresponding to a length of the corresponding first electrode in a width direction;
the second facing portion faces a corresponding second electrode and has a length corresponding to a length of the corresponding second electrode in the width direction;
the first connecting portion connects the first facing portion and the second facing portion to each other and covers a side surface of the corresponding first electrode; and
the second connecting portion connects the first facing portion in a first unit structure out of the adjacent unit structures to the second facing portion in a second unit structure out of the adjacent unit structures.
